(19) United States
(12) Patent Application Publication
(10) Pub. No.: US 2023/0110026 A1
(43) Pub. Date: Apr. 13, 2023

(54) PROCEDURE FOR REPAIRING A PICKING DEVICE

(71) Applicant: KNAPP Smart Solutions GmbH, Gelsenkirchen (DE)

(72) Inventor: Christian Bauer, Essen (DE)

(21) Appl. No.: 17/883,140

(22) Filed: Aug. 8, 2022

(30) Foreign Application Priority Data
Aug. 10, 2021 (DE) 10 2021 004 093.7

(51) Int. Cl. B65G 1/04

(52) U.S. Cl. CPC B65G 1/0421; B65G 1/0478; B65G 2203/0266; B65G 2207/40

(57) ABSTRACT

--A method for repairing a picking device, wherein the picking device comprises a rack to store goods; a storage retrieval system (AS/RS) configured for storing goods in specific locations of the rack and/or configured for retrieving goods located in a specific location of the warehouse; and a control unit designed to control movements of the storage retrieval system (AS/RS) and/or movements of components of the storage retrieval system (AS/RS), wherein the picking device includes a place of maintenance, wherein the controller is operative to move the storage retrieval system (AS/RS) to the maintenance station and/or the controller is operative to move the storage retrieval system (AS/RS) away from the maintenance station, the method comprising: moving a first storage retrieval system (AS/RS) to the maintenance station, removing the first storage retrieval system (AS/RS) from the picking device at the maintenance station, inserting a second storage retrieval system (AS/RS) into the picking device at the maintenance station, and moving the storage retrieval system (AS/RS) away from the maintenance station.

### FIELD OF INVENTION

The invention/creation relates to a procedure for repairing a picking device.

### BACKGROUND

A picking device has one rack to store goods. Further, an order picking device comprises a storage retrieval system (AS/RS) adapted to store goods in specific locations of the rack, for example, in a specific location on a shelf of a rack, and/or adapted to retrieve goods located in a specific location of the rack, for example, in a specific location on a specific shelf of a rack. Furthermore, a picking device has a control system. The controller is designed to control movements of the storage retrieval system (AS/RS) or movements of components of the storage retrieval system (AS/RS), whereby the term “control” in the sense of control engineering includes not only open-loop control but also closed-loop rules and is to be interpreted within the scope of a generic term for closed-loop control and closed-loop regulations.

Such picking devices are known from EP 2 826 732 A1, DE 10 2005 012 910 A1, EP 2 042 477 A1 and EP 1 564 160 A1.

### SUMMARY

In light of the aforementioned, the invention/creation was based on the task of creating a procedure for repairing a picking device that simplifies the repair.

This task is solved by the method pursuant to the present disclosure. Advantageous embodiments are given in the description that follow here.

The invention/creation proceeds from the basic idea of providing the picking device with a maintenance station, wherein the controller can move the storage retrieval system (AS/RS) to the maintenance station and/or the controller can move the storage retrieval system (AS/RS) away from the maintenance station, and in the course of the procedure according to the invention/creation
to move the first storage retrieval system (AS/RS) to the maintenance station,
remove the first storage retrieval system (AS/RS) from the picking device at the maintenance station,
insert the second storage retrieval system (AS/RS) into the picking device at the maintenance station, and
the second storage retrieval system (AS/RS) to proceed from the maintenance station.

The invention/creation makes use of the knowledge that the replacement of a complete storage retrieval system (AS/RS) according to the procedure pursuant to the invention/creation can be carried out more quickly in a large number of repair cases than carrying out a repair, in particular a maintenance and/or repair, on the respective storage retrieval system (AS/RS). While it is necessary according to the teaching of the prior art, to take the picking device out of regular operation for the entire duration of the repair, for example, maintenance or repair of a storage retrieval system (AS/RS), the method according to the invention/creation allows only the first storage and retrieval unit to be replaced by a second storage retrieval system (AS/RS) in the event of a repair. In the majority of repair scenarios, this replacement is faster than carrying out the repair itself.

In addition, the procedure, according to the invention/creation, offers the possibility that the repair of the storage retrieval system (AS/RS) does not have to be carried out on site. The procedure, according to the invention/creation, makes it possible for the storage retrieval system (AS/RS) to be changed on site and then the storage retrieval system (AS/RS) removed from the picking device to be moved to another location for repair. In the procedure, according to the invention/creation, it is even possible that the replacement of the storage retrieval system (AS/RS) is carried out by persons, for example the user of the picking device, who are not trained for the maintenance of the storage retrieval system (AS/RS) and/or do not have the tools and/or spare parts that may be necessary for the maintenance of the storage retrieval system (AS/RS).

In a preferred embodiment, the picking device comprises a rail leading from a work area located in front of the rack to the maintenance station, wherein the storage retrieval system (AS/RS) can be moved along the rail from the work area to the maintenance station and/or can be moved along the rail from the maintenance station to the work area.

In a preferred embodiment, the picking device has an interior space, with the maintenance station being outside the interior space.

In a preferred embodiment, a stacker crane that is moved away from the maintenance station into a work area of the storage retrieval system (AS/RS) performs a calibration run.

The picking device according to the invention/creation can be designed as a kind of high-bay racking, by which is meant that the rack of the picking device has a height of more than 4 m, in particular preferably more than 5 m, more preferably more than 6 m. In a particularly preferred embodiment, however, the picking device is not designed as a high-bay racking. In a preferred embodiment, the picking device is designed to be installed in a room of a commercial building, for example, in the room of a pharmacy. In a preferred embodiment, the height of the rack is <6 m, more preferably <5 m, more preferably <4 m, more preferably <3.50 m.

In a preferred embodiment, the rack is elongated. An elongated rack means a rack having a length in a longitudinal direction and having a width in a width direction perpendicular to the longitudinal direction and a height in a height direction perpendicular to the longitudinal direction and perpendicular to the width direction, wherein the length is greater than the width and the length is greater than the height. In a preferred embodiment, the length is at least 2 times, more preferably 2.5 times, more preferably 3 times, more preferably 3.5 times, more preferably 4 times greater than the width. In a preferred embodiment, the length is at least 2 times, more preferably 2.5 times, more preferably 3 times, more preferably 3.5 times, more preferably 4 times greater than the height. In a preferred embodiment, the height is at least 2 times, more preferably 2.5 times, more preferably 3 times, more preferably 3.5 times, more preferably 4 times greater than the width.

In a preferred embodiment, the rack has shelves. In a preferred embodiment, a shelf of the rack has a length in the longitudinal direction of the rack that is in the range of 50 mm to 500 mm. In a preferred embodiment, the shelf has a depth in the width direction of the shelf that is in the range of 5 mm to 500 mm. In a preferred embodiment, the rack has two shelves arranged one over the other, wherein the distance between the top of the lower shelf and the bottom of the upper shelf in the height direction of the shelf is in the range of 5 mm to 500 mm.

In a preferred embodiment, at least one, more preferably the majority (more than 50%), more preferably the vast majority (more than 75%) of the shelves present in the rack are made of plastic, more preferably glass, plexiglass, metal or wood. In a preferred embodiment, the majority (more than 50%), and more preferably the vast majority (more than 75%), of the shelves present are made of the same material.

In a preferred embodiment, the rack has a plurality of shelves, wherein in this particular embodiment, all shelves of the rack have the same length and the same depth, and all shelves of the rack are spaced the same distance apart. In a particularly preferred embodiment, not all shelves of the rack have the same length or the same depth or have the same distance from each other, namely at least one shelf having a different length from another shelf and/or a different depth from another shelf and/or a different distance from one shelf than another shelf has from another shelf.

In a preferred embodiment, the shelf is designed to support a load of 50 kg. A shelf may be braced to minimize deflection or achieve maximum flatness. Shelves with reduced adhesion can be provided, for example in the area of refrigerated racks. Shelves for areas of refrigerated racks / integrated refrigerators are possible, which allow the drainage of condensate, and are preferably made of perforated plate construction. In a preferred embodiment, an integrated collecting container is provided to drain the condensate in a defined direction. The shelves can be of grid construction.

In a preferred embodiment, at least one shelf of the rack, preferably the majority (more than 50% of the shelves present), more preferably more than 70% of the shelves present, and more preferably all of the shelves, are designed so that the surface, on which the goods are to be put, is horizontal.

In a preferred embodiment, the rack has drawer. In a preferred embodiment, the rack has drawers and shelves. In a preferred embodiment, the rack has more drawers than shelves. In an alternative embodiment, the rack has more shelves than drawers. In a preferred embodiment, the rack may be designed such that the drawer is open at the top and a free space is provided above the drawer into which a part of the storage retrieval system (AS/RS) can enter in order to drop the goods into the drawer from there. Likewise, embodiments are possible in which the drawer is open on one side, for example has no side wall or has an opening in the side wall, or is open at the rear end, for example has no rear wall or has an opening in a rear wall, so that an item can be placed in the drawer or removed from the drawer through the respective opening by means of the storage retrieval system (AS/RS). This makes it possible to place goods in the drawer and remove the goods from the picking device by pulling the drawer at least partially out of the rack. Likewise, in such an embodiment, it is possible to load the picking device with goods by pulling a drawer at least partially out of the rack, placing the goods in the drawer, and pushing the drawer back into the rack, in which position the storage retrieval system (AS/RS) then has access through the respective opening to the goods that have thus entered the rack.

The rack can be assembled from isolated rack modules.

In particular, the rack preferably has at least four rack posts, each rack post being located in one of four corners of the rack, wherein at least one shelf of the rack being located between the four rack posts. In a preferred embodiment, the shelf is rectangular, more preferably square, with each corner of the shelf adjacent a rack post. In a preferred embodiment, a rail is provided between a first rack post and a second rack post, with the shelf resting on the rail. In a preferred embodiment, another rail is provided between a third and a fourth rack post and is parallel to the rail, with the shelf supported on both rails. In a preferred embodiment, three rails are provided which together form the shape of a U, with the shelf resting on the three rails. In an alternative embodiment, four rails are provided, which together form a rectangle with a shelf resting on all four rails. Rails can, for example, be in the form of angle sections/profiles.

In a preferred embodiment, movable locking elements are provided for closing at least a portion of one side of the rack. For example, horizontally or vertically or obliquely sliding doors are provided. Such doors may be configured to close a first portion of one side of the rack in a first position and to close a second portion of the same side of the rack in a second position. In a preferred embodiment, such a door may then extend from the rack in a third position, in which it completely clears the side. Embodiments are possible, in which the locking element is designed as a roller shutter. Likewise, trapdoors in the manner of a guillotine are possible. Swivelling doors are conceivable, which can be swung around a horizontal axis or around a vertical axis. Locking one side of the rack can be used to protect the goods located behind the locking element from being accessed. Furthermore, closing the part of one side of the rack can be used to prevent collisions. If the part of one side of the rack is closed by a locking element, through which a storage retrieval system (AS/RS) would have access to the goods when the part of the side is open, closing this part of the side can prevent the storage retrieval system (AS/RS) from accessing the goods. This allows another storage retrieval system (AS/RS) or an operator to access the item manually without the risk of colliding with the storage retrieval system (AS/RS), which would otherwise also have access via the currently closed side.

In a preferred embodiment, the picking device, according to the invention/creation, is used for storing goods, in particular preferably used for storing goods whose length is between 10 and 400 mm and/or whose width is between 10 and 300 mm and/or whose height is between 10 and 200 mm.

The system according to the invention/creation has a device according to the invention/creation and a property located in the rack.

In a preferred embodiment, the picking device, according to the present invention, has multiple racks. In a preferred embodiment, the picking device, according to the invention/creation, has a first rack and a second rack running parallel to the first rack. In particular, the longitudinal direction of the first rack is preferably parallel to the longitudinal direction of the second rack. Designs are also conceivable in which a second rack is arranged at an angle, for example at 90°, to the first rack.

In a preferred embodiment, at least one, preferably the majority (more than 50%), more preferably the vast majority (more than 75%) of the racks present, and most preferably each rack present, has a rear wall. The rear wall is preferably provided on the side of the respective rack facing away from the other existing racks, so that the racks open towards an interior of the picking device. The rear panels may include openings, such as an ejection opening or an insertion opening. Drawers that may be provided in the rack can be pulled out from the rear panel in the direction of the rear panel. The rear panel can be a movable door or wall or a roller shutter.

In a preferred embodiment, at least one, preferably the majority (more than 50%), more preferably the vast majority (more than 75%) of the racks present, and most preferably each rack present, has at least one side panel. The side panel is preferably provided on the side of the respective rack facing away from the other existing racks, so that the racks open towards an interior of the picking device. The side panels may include openings, such as an ejection opening or an insertion opening. Drawers that may be provided in the rack can be pulled out from the rear panel in the direction of the side panel. The side panel can be at least partially designed as a movable door or wall or as a roller shutter.

In a preferred embodiment, at least one rack has a partition that protrudes at least on one side beyond the front edge of at least one shelf. The partition can run horizontally. The partition can run vertically. By means of a partition or, in a preferred embodiment, with a plurality of partitions adjoining one another, in particular preferably with a plurality of partitions adjoining one another and extending at an angle of 90° to one another, one part of the rack can be delimited from another part of the rack. Such a demarcation can be used, for example, to provide different climate zones in a rack. Refrigerators / shelving areas with cooling function are possible. The partitions can be used to guide a locking element, such as a shutter, which can close off an area of a rack delimited by partitions. For example, the rails of a roller shutter can be designed in partitions.

The partitions can be installed in a rack. If a rack is composed of modules, the partitions can be, for example, walls that delimit a module.

In a preferred embodiment, the rack has an area delimited at least on both sides, preferably on both sides as well as above and below by partitions, a so-called zone, wherein the front edges of the shelves provided in the zone are set back in relation to the front edge of the partitions, i.e. the front edge of the partitions protrudes with respect to the front edges of the shelves in this zone. The front edge of the shelves and the front edge of the partition wall are understood to be, in particular, the edge of the shelves or partition wall facing the storage retrieval system (AS/RS).

In a preferred embodiment, a partition extends in the height direction over a number of shelves.

In addition to or as an alternative to partitions which extend over several shelves and are preferably used to form zones in the rack, one or more partitions may be provided in the rack, each of which is provided between two shelves and divides the space between two shelves into compartments. Partitions used in this way preferably have front edges arranged in the same plane as the front edges of the two shelves, between which they are placed. Partitions inserted in this way can also be designed in such a way that their respective front edges, with respect to the plane in which the front edges of the two shelves, between which they are placed, are set back.

In a preferred embodiment, a shelf of a rack is arranged to be movable within the rack. For example, a shelf can be raised or lowered in the height direction of the rack by means of hydraulic tappets. Or a shelf can be moved in the longitudinal direction of the rack, for example in rails, or a shelf can be moved in the longitudinal direction of the rack, for example in rails.

In a preferred embodiment, at least a rear wall of a rack forms a boundary wall or part of a surrounding wall of the picking device according to the invention/creation. In a preferred embodiment, the picking device has a front side, a back side, and two side walls, wherein
the front is formed at least in parts from a rear wall or a side wall of a rack of the picking device and/or
the rear side being formed at least in parts from a rear wall or a side wall of a rack of the picking device and/or
at least one of the side walls is formed at least in parts from a rear wall or a side wall of a rack of the picking device.

A door or window may be provided in the front, rear, and/or one of the side walls of the picking device with a movable sash, which is installed in a window frame and closes the window frame in a closed position.

The front side, the rear side and/or at least one of the side walls of the picking device can be formed at least in parts by a transparent material, so that a view from the outside into an interior of the picking device is possible. As an alternative or complement, the front side, the rear side and/or at least one of the side walls of the picking device can be formed at least in parts by a display, in particular preferably a touch-sensitive display. A display designed in this way can be used to give the front, the back and/or at least one of the side walls a special appearance (a special wall color, which can also change, for example, depending on the time of day) or can be used as an advertising space. A display implemented in this way, in particular preferably a touch-sensitive display, can be part of an interface, with which a user can interact with the control of the picking device.

In a preferred embodiment, the picking device has a roof. In a preferred embodiment, the roof rests on the rack or shelves of the picking device. In an alternative embodiment, the roof is at least partially formed by the top of the rack or the tops of the racks, wherein additionally at least one ceiling element is provided which at least partially closes the area of the picking device in which no rack is located from the top. Preferably, the areas of the picking device where there is no rack are completely closed from above by one ceiling element or by several ceiling elements. The ceiling elements may have hatches. The ceiling elements can be closed ceiling elements, for example, plastic, metal or wooden panels. However, the ceiling elements can also be designed as grid units.

In a preferred embodiment, the picking device has a conveyor belt. In a preferred embodiment, the conveyor leads from an area outside a rack into the rack, preferably into a space between two shelves of a rack. Such a conveyor belt can be used to transfer goods from outside an interior of the picking device to an interior of the picking device. Such a conveyor belt can be used to move goods from inside an interior space of the picking device to an area outside this interior space of the picking device. Such a conveyor belt can also be used for this purpose,
in a first mode of operation of the picking device (the “storing”), transferring goods from outside an interior space of the picking device into an interior space of the picking device, and
in a second mode of operation of the picking device (the “retrieval”), to transfer goods from inside an interior space of the picking device to an area outside this interior space of the picking device.

In a preferred embodiment, the picking device has a conveyor belt;
a first conveyor belt used to move goods from outside an interior space of the picking device into an interior space of the picking device (“storage belt”), and
a second conveyor belt used to move goods from inside an interior space of the picking device to an area outside this interior space of the picking device (“retrieval belt”).

In addition or as an alternative to the storage conveyor belt, the picking device in this embodiment may include a storage slide or storage drawers. In addition or as an alternative to the retrieval conveyor belt, the picking device in this embodiment may include a retrieval slide or retrieval drawers. The picking device can have a wheel conveyorboth within the scope of the storage and retrieval operations.

The picking device can have a isolation unit, in particular a pick & place isolation unit, a feeder isolation unit or a isolation unit.

In a preferred embodiment, the picking device has a transfer unit. In a preferred embodiment, the transfer unit is a gripper jaw. In a preferred embodiment, the transfer unit is designed to be movable between a pick-up position and a stacking position.

In a preferred embodiment, the transfer unit is in its pick-up position above a loading station. The loading station can be a fixed surface, for example a fixed top [surface area], on which an operator of the picking device can place an item or to which the item to be placed arrives by other means, for example by a slide at the end of which the fixed surface is arranged or from the end of which the item falls onto the fixed surface. The loading station can be the bottom of a drawer. The loading station can be a certain area of a conveyor belt. The loading station can be the surface of a movable tray. The loading station can be located outside an interior space of the picking device, for example when the transfer unit is used in the course of storing the goods. The loading station can be located within the interior space of the picking device, for example when the transfer unit is used in the course of retrieving the goods.

In a preferred embodiment, the transfer unit is in its stacking position above a stacking station. The stacking station can be a fixed surface, such as a fixed top [surface area], from which the storage retrieval system (AS/RS) can pick up an item. The stacking station can be a specific area of a conveyor belt. The stacking station can be the surface of a movable tray. The stacking station can be located outside an interior space of the picking device, for example when the transfer unit is used in the course of retrieving the goods. The stacking station may be located within an interior space of the picking device, for example, when the transfer unit is used in the course of storing the goods.

In a preferred embodiment, the picking device comprises an identification station comprising at least one identification device that can be used to determine at least one characteristic of a property. The identification station may also have several identification devices, in particular preferably at least two identification devices, each of which determines different characteristics of the goods. In a preferred embodiment, at least one of the existing identification devices, in particular preferably the majority (more than 50%) and in particular preferably the vast majority (more than 75%) of the existing identification devices is connected to the controller for data exchange, for example via a radio connection, such as Bluetooth or via a cable connection.

An identification device that can be used in an identification station can be a laser that can be used to determine at least one dimension of the goods.

An identification device that can be used in an identification station can be a barcode reader and/or a QR code reader, which can be used to determine at least one barcode on the goods.

An identification device that can be used in an identification station can be an RFID reader that can be used to determine a passive or active RFID tag of the item.

An identification device that can be used in an identification station can be a camera with which, for example, an image of the goods can be recorded and/or with which, using image analysis methods, at least one dimension of the goods can be determined and/or with which, using image analysis methods (OCR methods), at least one text printed on the goods, for example a sell-by date or a description of the goods, can be determined.

An identification device that can be used in an identification station can be a temperature measuring device that can be used to determine at least one dimension of the goods.

An identification device that can be used in an identification station can be a scale that can be used to determine the weight of the goods.

An identification device that can be used in an identification station can be an X-ray device that can be used to take at least one X-ray image of the goods.

In a preferred embodiment, the identification station is arranged
within the scope of a loading station and/or
within the scope of a stacking station and/or
arranged on the route taken by a transfer unit between a loading station and a stacking station, in particular in the form of an intermediate location onto which the transfer unit briefly deposits the goods for identification purposes.

The identification station may be used to identify at least one property in a certain stack of goods while the goods is in storage. The identification station may be used to identify at least one property of a certain stack of goods during retrieval of the goods. The same identification station may be used to identify at least one property of a commodity during storage of the certain stack of goods and to identify at least one property in a certain stack of goods during retrieval of the goods. In a preferred embodiment, the picking device has a conveyor belt;
An initial identification station for identifying at least one property of a certain stack of goods during storage of the goods, and
a second identification station for identifying at least one property of a certain stack of goods during retrieval of the goods.

In a preferred embodiment, the picking device has a task formed by a location disposed outside an interior of the picking device and accessible to an operator of the picking device. The loading can be carried-out in the loading station, above which a transfer unit can be in its pick-up position. In an alternative embodiment, a means of conveyance, for example, a conveyor belt, slide, or movable tray, or a series of conveyors, for example, is
several conveyor belts connected in series or
a slide, in particular a spiral slide, or a spiral slide, wheel conveyor with a downstream conveyor belt onto which an item falls from the slide or wheel conveyor, or
a conveyor belt with a slide into which a material conveyed by the conveyor belt falls at the end of the conveyor belt,
the machine is equipped with a transport system for transporting the goods from the loading point to the loading station.

In a preferred embodiment, the picking device has a transfer station from which a storage retrieval system (AS/RS) can pick up a property. The transfer unit/station can be the stacking station above which a transfer unit is in its stacking position. In an alternative embodiment, a means of conveyance, for example, a conveyor belt, slide, in particular a spiral slide, or movable tray, or a series of conveyors, for example, is
several conveyor belts connected in series or
a slide, in particular a spiral slide with a downstream conveyor belt onto which a material falls from the slide or
a conveyor belt with a slide into which a material conveyed by the conveyor belt falls at the end of the conveyor belt,
the machine is equipped with a transport system for transporting the goods from the stacking station to the transfer unit/station.

In a preferred embodiment, the picking device has a loading conveyor path between the loading point and the transfer unit/station, along which the goods are moved from the feed to the transfer unit/station, the route of the feed conveyor path being defined by a single means of conveyance, for example a conveyor belt, a slide or movable tray, or a series connection of means of conveyance, for example
several conveyor belts connected in series or
a slide, in particular a spiral slide with a downstream conveyor belt onto which a material falls from the slide or
a conveyor belt with a slide into which a material conveyed by the conveyor belt falls at the end of the conveyor
belt, In a preferred embodiment, the means of conveyance is the transfer unit. In an alternative, also preferred embodiment, the transfer unit is one of the conveyors connected in series to form the feed conveyor path. In an alternative, also preferred embodiment, the transfer unit is not one of the conveyors that are connected in series to form the feed conveyor path; in this embodiment, therefore, the material is transported from the feed to the transfer station along the feed conveyor path without a transfer unit.

In a preferred embodiment, the identification station is arranged
within the scope of loading and/or
within the scope of the transfer station and/or
arranged along the feed conveyor path.

In a preferred embodiment, the picking device has a release/output formed by a location disposed outside an interior of the picking device and accessible to an operator of the picking device. The release/output can be carried-out through the deposit location, above which a transfer unit can be in its stacking position. In an alternative embodiment, a means of conveyance is provided, for example, a conveyor belt, slide, or movable tray, or a series of conveyors, for example,
several conveyor belts connected in series or
a slide with a downstream conveyor belt onto which an item falls from the slide or
a conveyor belt with a slide into which a material conveyed by the conveyor belt falls at the end of the conveyor, or
with a conveyor system for transporting the goods from the stacking station to the output.

In a preferred embodiment, the picking device has a transfer station from which a storage retrieval system (AS/RS) can pick up a property. The transfer unit can be the same location, from which a storage retrieval system (AS/RS) can pick up a good. In a preferred embodiment, the picking apparatus includes a first transfer unit provided for a storage retrieval system (AS/RS) to pick up an item therefrom, and a second transfer unit provided for a storage retrieval system (AS/RS) to deposit goods on it. The second transfer station in question here may be the pick-up station, above which a transfer unit is located in its pick-up. In an alternative embodiment, a means of conveyance is provided, for example, a conveyor belt, slide, or movable tray, or a series of conveyors, for example,
several conveyor belts connected in series or
a slide with a downstream conveyor belt onto which an item falls from the slide or
a conveyor belt with a slide into which a material conveyed by the conveyor belt falls at the end of the conveyor,
with which or by means of which the goods are transported from the, possibly second, transfer unit in question to the pick-up point.

In a preferred embodiment, the picking device has a feed conveyor path between the transfer unit/station and the output along which the goods are moved from the transfer unit/station to the feed point, the route of the output conveyor path being followed by a single means of conveyance, for example a conveyor belt, a slide or movable tray, or a series connection of a means of conveyance, for example,
several conveyor belts connected in series or
a slide with a downstream conveyor belt onto which an item falls from the slide or
a conveyor belt with a slide, into which a material conveyed by the conveyor belt falls at the end of the conveyor
belt. In a preferred embodiment, the means of conveyance is the transfer unit. In an alternative, also preferred embodiment, the transfer unit is one of the conveyors connected in series to form the output conveyor path. In an alternative, also preferred embodiment, the transfer unit is not one of the conveyors that are connected in series to form the output conveyor path; in this embodiment, therefore, the material is transported from the output area to the transfer unit/station along the output conveyor path without a transfer unit.

In a preferred embodiment, the identification station is arranged
Within the scope of the output and/or
within the scope of the transfer station and/or
arranged along the output conveyor path.

In a preferred embodiment, the route of the output conveyor path corresponds to that of the feed conveyor path. In an alternative embodiment, a portion of the route of the output conveyor path corresponds to the route of the feed conveyor path or a portion of the route of the feed conveyor path. In an alternative embodiment, a portion of the route of the feed conveyor path corresponds to the route of the output conveyor path or a portion of the route of the output conveyor path. In an alternative embodiment, the route of the output conveyor path and the route of the feed conveyor path are different.

In a preferred embodiment, the picking device has a user interface. The user interface allows the user to interact with the control unit of the picking device. The user interface can be
a keyboard and/or
a computer mouse or touchpad and/or
a touch-sensitive display and/or
a microphone for voice control and/or
a connection for reading a storage medium, for example, USB stick, CD, DVD and/or
a reader for reading an RFID tag or an antenna for communication according to a radio/wireless standard, for example Bluetooth or NFC,
which are designed as part of the picking device and are connected in particular with a wireless connection, for example via Bluetooth, or via cable to the controller of the picking device. Supplementary or alternatively, the user interface may be a WLAN or LAN interface or an interface for a telephone network or an interface for the Internet, for example a router, with which the user can interact with the control of the picking device via a network, for example a telephone network or a computer network, in particular a WLAN connection, a LAN connection or via the Internet.

In a preferred embodiment, the picking device comprises a climate control device for heating or cooling at least a portion of an interior of the picking device. In a preferred embodiment, in which a zone can be formed by partitions in a rack, the climate control device can be designed to influence the temperature in the zone by heating and/or cooling and, in particular, preferably to maintain the temperature within a predetermined temperature range and, in particular, at a specific temperature. For example, a zone for holding refrigerated goods can be maintained at a temperature range of 3° C. to 7° C. In a preferred embodiment, in which the temperature in a zone delimited by partition walls is influenced by means of a climate control device, the partition walls are designed with insulation. Likewise, it is possible to use the climate control device to prevent the temperature in the entire interior of the picking device from rising above a certain value, for example, from rising above 35° C.

In a preferred embodiment, the picking device has illumination that can be used to at least partially illuminate an interior of the picking device. The illumination can be used to illuminate a part of the interior in front of a rack or between several racks. Illumination may also be used for accentuation, for example, each shelf may be equipped with illumination/lighting that may be controlled, for example, so that the illumination illuminates when a property is stored in that shelf by means of the storage retrieval system (AS/RS) or when a good is retrieved from that shelf by means of the storage retrieval system (AS/RS).

In a preferred embodiment, a rack of the picking device can be designed to be movable and, in particular, can preferably be moved into different positions within the picking device. For example, for better space utilization, the distance between two racks can be reduced in movable racks, if, at that moment, it is not necessary to access a property that is located in one of the two racks. In an alternative embodiment, all racks of the picking device are stationary and immovable.

In a preferred embodiment, the picking device has an interior space. In a preferred embodiment, the picking device has a front, a back and two side walls and a roof, wherein in this embodiment the interior space is the space bounded by the front, the back and the two side walls as well as the floor on which the picking device stands or a floor surface of the picking device, if any, and the roof. In this embodiment, if the picking device does not have its own roof, but has a front, a back, and two side walls, the interior space is the space bounded by the front, the back, and the two side walls, as well as the floor on which the picking device stands or a floor surface of the picking device, if any, and the horizontal plane containing the highest point of the picking device.

In a preferred embodiment, the storage retrieval system (AS/RS) has a manipulator. A manipulator is understood to be a device that can change the position and/or orientation of a property in space. A change of location means that a property is moved from a first location to a second location. A change of orientation means that a good remains at the same location but is oriented differently at this location, for example rotated around an axis.

A manipulator can be used by means of
positive-locking fit and/or
frictional locking and/or
magnetic force and/or
suction power and/or
adhesion
change the location and/or orientation of the property.

In a preferred embodiment, the manipulator includes a slider, wherein a slider is understood to be a device capable of exerting a pushing force on the item, but not a pulling force.

In a preferred embodiment, the manipulator has a hook, in particular a plurality of hooks or claws, wherein a hook is understood to be a device that has a recess by means of which an at least part of the item can be gripped behind and a pulling force can be applied to the item.

In a preferred embodiment, the manipulator has a suction device, wherein a suction device is understood to mean a device that can apply a suction force to the material and, in particular, can preferably hold the material in a position relative to the suction device by applying a suction force, so that the material can also be moved by moving the suction device, for example, a pulling movement can be applied to the material held on the suction device by means of suction force by moving the suction device.

In a preferred embodiment, the manipulator comprises a movable magnet, wherein the item can be held against the magnet by the magnetic force and thus a movement of the magnet can be transmitted to the item.

In a preferred embodiment, the manipulator has a gripper. A gripper has at least two gripping elements, wherein at least one gripping element can be moved relative to the other gripping element so that the distance between the first gripping element and the second gripping element can be changed. The gripper can function, for example, in the manner of pliers. Embodiments are possible, in which the position of one gripping element is fixed within the manipulator and the change in distance between the one gripping element and the other gripping element is brought about solely by movements of the one gripping element. In a particularly preferred embodiment, however, both gripping elements can be moved relative to the respective other gripping element, so that the distance between the gripping elements can be changed by moving both gripping elements.

In a preferred embodiment, the storage retrieval system (AS/RS) has a support platform. In a preferred embodiment, the manipulator is put over the support platform. In a preferred embodiment, the manipulator or a part of the manipulator that is part of the manipulator can be moved relatively to the support platform. For example, if the manipulator is designed as a gripper, the manipulator can grasp a property lying on the support platform and, by its movement relative to the support platform, store the property from the support platform into the rack. By moving the manipulator or part of the manipulator relative to the support platform, goods can be retrieved from the rack. For this purpose, the manipulator or the part of the manipulator is moved into the rack relatively to the support platform, where it grips the item to be retrieved, for example, or exerts a pulling force on the item to be retrieved and retrieves the item to be retrieved from the rack onto the support platform.

In a preferred embodiment, the storage retrieval system (AS/RS) has a base frame. In a preferred embodiment, the manipulator is designed to be movable relatively to the base frame. In a preferred embodiment, a support platform, if present, is designed to be movable relative to the base frame. In a preferred embodiment, the manipulator and/or the support platform are designed to be movable in a vertical direction relatively to the moving base frame. In a preferred embodiment, the manipulator and the support platform are part of an assembly that can be moved, as a whole, relatively to the main base frame.

In a preferred embodiment, the base frame is formed at least in part by a column, in particular preferably a vertical column.

In a preferred embodiment, the base frame, in particular preferably a column forming part of the base frame, has a rail, wherein the manipulator is guided in its movement relative to the base frame, or an assembly comprising the manipulator is guided in its movement relatively to the base frame, by the rail.

The movement of the manipulator, or of an assembly comprising the manipulator, relative to the base frame can be
by a hydraulic and/or pneumatic cylinder connected at one end to the base frame and at its other end to the manipulator or assembly, and/or
by a toothed rack and a driven pinion, whereby, for example, the toothed rack can be arranged on the base frame and the manipulator or the assembly has a driven pinion, by the movement of which the manipulator or the assembly can move along the toothed rack, and/or
take place in the manner of a magnetic monorail [magnetic-levitation train] and/or
by a rope or a belt or toothed belt which is connected at one end to the manipulator or the assembly and is wound or unwound onto a winch on the base frame or which is connected at one end to the base frame and is wound or unwound onto a winch on the manipulator or the assembly, and/or
by a loop of a toothed belt, or toothed belt, to which the manipulator, or the assembly, is connected, wherein the toothed belt is in engagement with at least one pinion on the base frame and by moving the toothed belt, for example by driving the pinion, the manipulator, or the assembly, can be moved relative to the base frame, and/or
by means of a recirculating ball screw and/or
a driven friction wheel that runs along a friction surface, for example a driven friction wheel provided on the manipulator or assembly that runs along a friction surface on the base frame.

In a preferred embodiment, the storage retrieval system (AS/RS) has a condition monitoring system/unit. The condition monitoring system can be composed of isolated modules. The state monitoring system can
determine the position of the manipulator and/or the position of any provided assembly, of which the manipulator is a part, relative to the base frame,
determine the position of the manipulator or a part of the manipulator, for example a gripping arm, relative to other parts of an assembly to which it belongs, for example relative to a support platform,
determine the position of one part of the manipulator relative to another part of the manipulator, for example the position of a gripping arm relative to another gripping arm,
determine the position of the storage retrieval system (AS/RS) or a part of the storage retrieval system (AS/RS) relative to other parts of the picking device, for example the positioning of the base frame relative to a reference point of the picking device or else the position of the manipulator associated with the storage retrieval system (AS/RS) relative to a reference point on a rack of the picking device.

The position of an object relative to another object is understood in particular as the distance of a reference point of one object relative to a reference point of the other object and/or the angle by which the one object has been rotated about a rotation axis relative to the other object, starting from a reference position.

The condition monitoring system may include measurement devices [gages] to determine the layers, such as
a laser measuring device with which a distance can be measured,
an angle encoder that can be used to measure the angle through which an object has rotated,
a photoelectric barrier that can be used to check whether an object has reached a specific reference point or to check whether an object has passed a specific reference point,
a pressure sensor that can be used to determine whether an object is bumping against another object,
a vision camera,
a displacement measuring system,
an ultrasonic sensor,
a laser triangulation sensor,
a wire-rope sensor.

In a preferred embodiment, the storage retrieval system (AS/RS) can be moved relative to the rack. In a preferred embodiment, the storage retrieval system (AS/RS) is moved along a predetermined path relative to the rack. In a preferred embodiment, the storage retrieval system (AS/RS) is guided on a rail. In a preferred embodiment, a base frame of the storage retrieval system (AS/RS) is guided on a rail. In a preferred embodiment, the storage retrieval system (AS/RS) is guided on an upper rail and on a lower rail. In a preferred embodiment, a rail runs parallel to a rack.

The movement of the body frame of the storage retrieval system (AS/RS) relative to the rack can be
by a hydraulic and/or pneumatic cylinder connected at one end to the base frame and at its other end to the rack, and/or
by a toothed rack and a driven pinion, whereby, for example, the toothed rack can be arranged on the rack and the base frame has a driven pinion, by the movement of which the base frame can move along the toothed rack, and/or
take place in the manner of a magnetic monorail [magnetic-levitation train] and/or
by a rope or belt or toothed belt which is connected at one end to the rack and is wound or unwound onto a winch on the base frame or which is connected at one end to the base frame and is wound or unwound onto a winch on the rack, and/or
by a loop of a toothed belt, or toothed belt, to which the rack is connected, the toothed belt being in engagement with at least one pinion on the base frame, and by moving the toothed belt or the pinion, for example by driving the pinion, the base frame can be moved relative to the rack, and/or
by means of a recirculating ball screw and/or
a driven friction wheel running along a friction surface, for example a driven friction wheel provided on the base frame running along a friction surface on the rack or on the floor in front of the rack.

The procedure according to the present invention/creation stipulates, that
an item that was not previously positioned at a specific storage location in a rack of the picking device is positioned at this specific storage location in the rack by means of the storage retrieval system (AS/RS),
or
an item that was previously positioned at a specific storage location in a rack of the picking device is removed from this specific storage location by the storage retrieval system (AS/RS).

In a preferred embodiment, an item to be stored at a specific storage station in the rack is stored in a preliminary process step
is held by the manipulator and/or lies on a support platform of a storage retrieval system (AS/RS) and is moved with the storage retrieval system (AS/RS) relative to the rack and/or is moved into a transfer position by a movement of the manipulator or an assembly comprising the manipulator relative to a base frame of the storage retrieval system (AS/RS) relative to the rack and
after reaching the transfer position, moves the manipulator or a part of the manipulator to the specified storage station.

In a preferred embodiment, an item to be retrieved from a particular storage station in the rack is
removed from the designated storage place by a movement of the manipulator or a part of the manipulator, and
moved with the storage retrieval system (AS/RS) relative to the rack and/or moved to a transfer position by a movement of the manipulator or an assembly comprising the manipulator relative to a base frame of the storage retrieval system (AS/RS) relative to the rack, while the good is held by the manipulator and/or lies on a support platform of a storage retrieval system (AS/RS).

The picking device according to the invention/creation and/or the procedure according to the invention/creation are in particular preferably used for storing and/or retrieving goods whose length is between 10 and 400 mm and/or whose width is between 10 and 300 mm and/or whose height is between 10 and 200 mm.

The picking device according to the invention/creation and/or the procedure according to the invention/creation are in particular preferably used for storing and/or retrieving goods which are not dimensionally stable, for example bags or sacks.

### BRIEF DESCRIPTION OF THE DRAWINGS

In the following, the invention is explained more closely with the aid of drawings showing merely realizations. It can be demonstrated as follows:

FIG. 1 is a perspective view of the so-called storage side of a picking device according to the invention/creation;

FIG. 2 is a perspective view of the back of the picking device according to FIG. 1;

FIG. 3 is a top view of the rear side of the picking device according to FIG. 1;

FIGS. 4 and 4a show a sectional view of a part of the measuring roller according to the invention/creation along section line A-A in FIG. 3;

FIGS. 5 and 5a show a sectional view of the picking device according to FIG. 1 along the line B-B in FIG. 3;

FIG. 6 is a top view of a first side of the picking device according to FIG. 1;

FIG. 7 is a top view of a second side of the picking device according to FIG. 1;

FIG. 8 is a top view of the picking device according to FIG. 1;

FIG. 9 is a sectional view of the picking device according to FIG. 1 along the line C-C in FIG. 8;

FIG. 10 is a top view of the storage side of the picking device according to FIG. 1;

FIG. 11 is a sectional view of the picking device according to FIG. 1 along the line D-D in FIG. 10;

FIG. 12 is a perspective view of a storage retrieval system (AS/RS) of the picking device according to FIG. 1 with a first type of manipulator;

FIG. 13 is a perspective view of a storage retrieval system (AS/RS) of the picking device according to FIG. 1 with a second type of manipulator;

FIG. 14 is a perspective view of a first type of manipulator of a storage retrieval system (AS/RS) of the picking device according to FIG. 1, and

FIG. 15 is a perspective view of a second type of manipulator of a storage retrieval system (AS/RS) of the picking device according to FIG. 1.

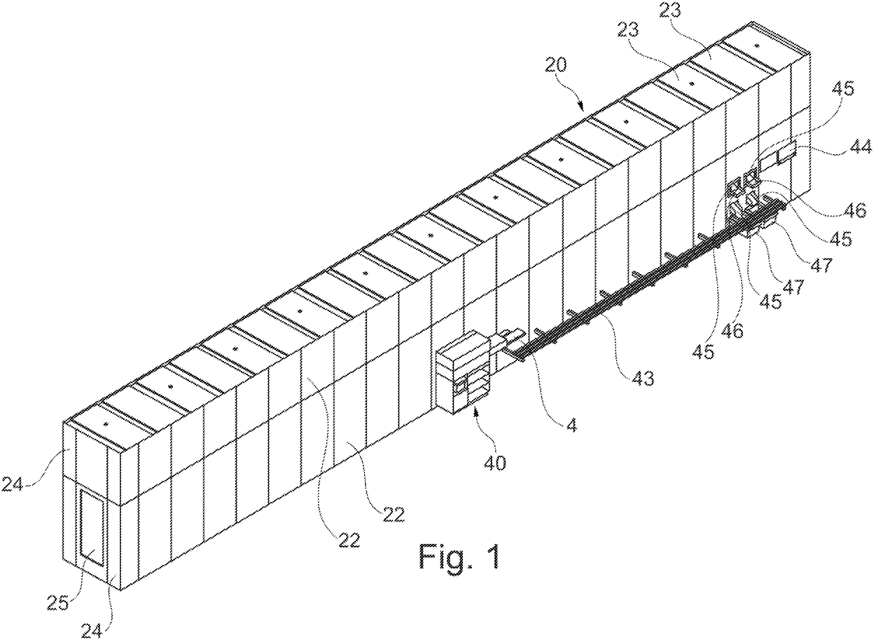

### DETAILED DESCRIPTION

The picking device (1) shown in Figs. has two rows of racks (2) facing each other. Each rack row (2) consists of a plurality of individual rack modules (3). Each shelving module (3) has vertical struts (4) and shelves (5) arranged between the struts (4) and attached to them. For reasons of clarity, the rack modules (3) are shown with a small number of shelves (5). Depending on the size of the goods to be stored, the number of shelves (5) can be adjusted. When storing flat goods, for example packages of the size of a medicine pack, smaller distances between the shelves (5) are necessary than when storing high goods, such as bottles. Thus, for a shelving module 3 intended for storing flat goods, the number of shelves (5) can be increased, since they can be arranged at a smaller distance one above the other than is the case for a shelving module (3) for storing lengthy goods. Within the picking device (1), the pattern of shelves provided in the rack modules (3) may vary. Thus, individual rack modules (3) or even individual areas of individual rack modules (3) can be reserved for the storage of specific goods and equipped accordingly. Thus, areas of the rows of racks (2) are conceivable within which the shelves (5) are arranged relatively close to one another; these areas are then used for storing flat goods. Likewise, areas of the rack rows 2 are conceivable within which the shelves (5) are arranged one over the other at a relatively great distance from one another; these areas are then used for storing lengthy goods.

Furthermore, it is possible to equip individual areas of the rack row (2) for special storage conditions, for example with a cooling system or with an air conditioning system that sets a certain humidity. Refrigeration, which can also be equipped as a freezer, can be used for storing refrigerated goods. Air-conditioned areas in which the air humidity is adjusted by means of the air-conditioning system can be used, for example, for storing goods that should be stored in a particularly dry state, or, for example, for storing goods that should be stored in a particularly moist state, such as fresh vegetables. The areas of rack row (2) equipped for special storage conditions may have insulated walls. Likewise, it may be provided that a shelving module (3) belonging to a specially equipped area of a rack row (2) is provided with a locking element, such as a roller shutter, facing towards the aisle (6), which closes the rack module 3 towards the aisle 6, thus facilitating the setting of the special storage conditions inside the rack module (3), but at the same time allowing access to an item stored in this rack module (3) under special storage conditions by opening the locking element, for example by raising the roller shutter.

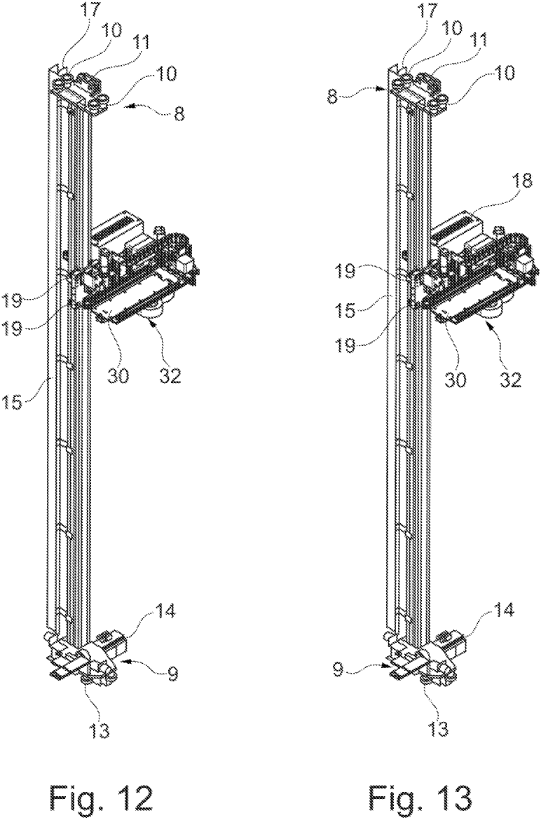

The rows of racks (2) facing each other form an aisle (6) between them. In the aisle (6), there are two storage retrieval system (AS/RS) (7), also called handling equipment (HHG). Each storage retrieval system (AS/RS) (7) can be moved along the rows of racks (2). As FIGS. 12, 13 show particularly well, the storage retrieval system (AS/RS) (7) has a head guide (8) and a foot guide (9). The head guide (8) has two pairs of rollers (10). A head guide (not visualized) is guided through the two pairs of rollers (10), on which the two pairs of rollers (10) roll. Another pair of rollers 11 supports the storage retrieval system (AS/RS) 7 against the ceiling 20 of the picking device 1 and rolls on the ceiling 20. The foot guide (9) has two pairs of rollers (13). A foot guide (not visualized) is guided through the two pairs of rollers (10), on which the two pairs of rollers (13) roll. Another pair of rollers (11) supports the storage retrieval system (AS/RS) (7) against the body (21) of the picking device (1) and rolls on the body (21). The foot guide (9) has a cutout (14). The drive (14) drives a toothed wheel that engages the teeth of the foot belt, which is not shown and is designed as a toothed belt. The foot strap and the head strap are stationary in the picking device (1). One foot strap and one head strap each extend along a rack row (2). By turning a gear engaged with the teeth of the foot strap, the drive (14) can move the storage retrieval system (AS/RS) (7) along the stationary foot strap and thus move the storage retrieval system (AS/RS) (7) along the rack row (2).

The relative position of the storage retrieval system (AS/RS) (7) with respect to the rack row (2) can be determined and monitored as follows: A reference point of the storage retrieval system (AS/RS) (7) is defined in relation to the rack row (2). This reference point can, for example, be an end stop, i.e. a stop at the end of the rack row (2) beyond which the storage retrieval system (AS/RS) (7) cannot be moved. In a preferred embodiment, two reference points are provided, for example two end stops, namely one end stop at each end of the rack row (2), between which the storage retrieval system (AS/RS) (7) can move relative to the rack row (2). The position of the storage retrieval system (AS/RS) (7) relative to the reference point can now be determined from the tooth pitch of the stationary foot strap and monitoring of the number of revolutions of the gear wheel of the drive (14). Calibration runs and regular inspection runs are possible.

The storage retrieval system (AS/RS) (7) has a vertical column 15. The head guide (8) is provided at the upper end of the column (15); the foot guide (9) is provided at the lower end of the column (15).

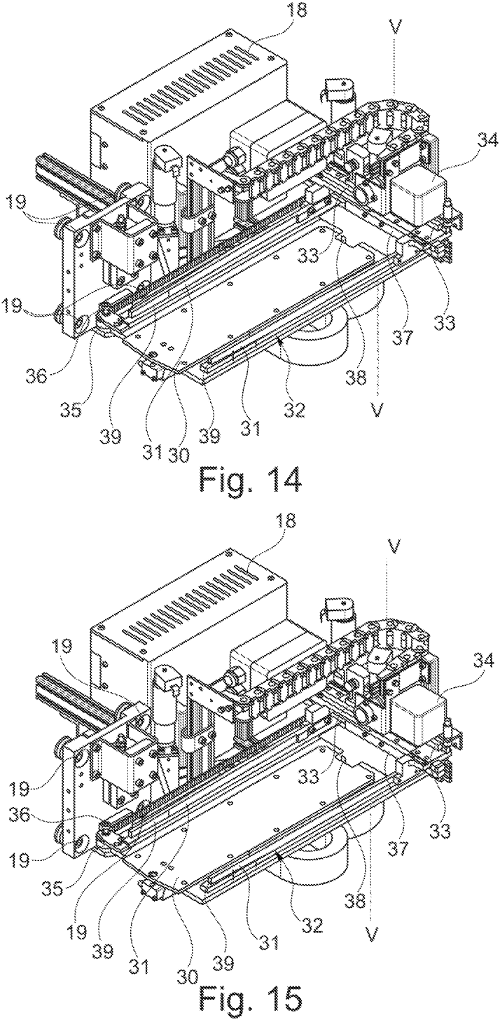

A vertically movable manipulator (16) is provided on the column 15 (refer also to FIGS. 14, 15). The column (15) has a toothed rail (17). A toothed rail (not shown in more detail) engages in the toothed rail 17 and can be rotated by a drive (18). By turning the gear wheel, the manipulator (16) can be moved along the toothed rail (17), which is stationary on the column (15), and thus along the column (15). The manipulator has a guide plate with rollers (19) that roll along vertical guide surfaces on the column (15) and stabilize the movement of the manipulator 16 along the column (15).

The relative position of the manipulator (16) with respect to the column (15) can be determined and monitored as follows: A reference point of the manipulator (16) is defined in relation to the rack row (2). This reference point can, for example, be an end stop, i.e. a stop at the end of the rack row (15) beyond which the storage retrieval system (AS/RS) (16) cannot be moved. In a preferred embodiment, two reference points are provided, for example two end stops, namely one end stop at each end of the column (15), between which the manipulator (16) can move relatively to the column (15). The position of the manipulator (16) relative to the reference point can now be determined from the tooth pitch of the toothed rail (17) and monitoring of the number of revolutions of the gear wheel of the drive (18). Calibration runs and regular inspection runs are possible.

The manipulator (16) includes a support surface (30) on which goods may be supported during transport of the goods in the manipulator (16). In the embodiment example according to FIGS. 14, 15, the supporting surface (30) is of stationary design. Embodiments are also possible, in which the support surface (30) is designed to be linearly movable.

The manipulator (16) has two forks (31), which together form a gripper jaw (32). Toothed racks (33) are provided at the end of the forks (31). A drive (34) can drive a gear wheel, not shown in more detail, arranged between the toothed racks (33). One toothed rack (33) is located on one side of the toothed wheel; the other toothed rack (33) is located on the other side of the toothed wheel. Turning the gearwheel moves the toothed racks (33) past the toothed wheel. Due to the arrangement of the toothed racks (33) on opposite sides of the toothed wheel, the toothed racks (33) are rotated in opposite directions when the gear is turned. This movement of the toothed racks (33) can increase or decrease the distance between the forks (31), depending on whether turning the toothed wheel moves the toothed racks (33) toward or away from each other.

The relative position of the forks (31) to each other can be determined and monitored as follows: A reference point is set. This reference point can be, for example, the fully closed position in which the tips of the forks (31) are against each other and further rotation of the toothed wheel is no longer possible. The position of the forks (31) relative to each other can now be determined from the tooth pitch of the toothed racks (33) and from monitoring the number of revolutions of the toothed wheel of the drive (34). Calibration runs and regular inspection runs are possible.

The manipulator (16) has a revolving toothed belt 36 guided over rollers (in FIGS. 14, 15 only the roller (35) at the front end is visible). The timing/toothed belt (36) runs along the support surface 30. A carrier (37), which also carries the drive (34), the forks (31) and the toothed racks (33), is connected to the timing/toothed belt (36). A drive, not shown in detail, drives the timing/toothed belt (36) so that the timing/toothed belt (36) revolves around the rollers (35). Because of the connection with the timing/toothed belt (36), when the timing/toothed belt (36) moves, the carrier (37) and with it the drive (34), the forks (31) and the toothed racks (33) also move, along and over the support surface (30).

In an alternative embodiment, it is possible for the timing/toothed belt (36) to be a stationary toothed rack and for the carrier (37) to have a drive with a toothed racks (33). By turning the gear, the carrier (37) can be moved along the stationary rack. The relative position of the carrier (37) with respect to the support surface (30) can be determined and monitored as follows: A reference point of the carrier (37) is defined in relation to the support surface (30). This reference point can, for example, be an end stop, i.e. a stop at the end of the support surface (30) beyond which the carrier (37) cannot be moved. In a preferred embodiment, two reference points are provided, for example two end stops, namely one end stop at each end of the support surface (30), between which the carrier (37) can move relatively to the support surface (30). The position of the carrier (37) relative to the reference point can now be determined from the tooth pitch of the toothed rack and monitoring of the number of revolutions of the gear wheel of the drive. Calibration runs and regular inspection runs are possible.

A slider (38) is provided on the carrier (37). With goods resting on the support surface (30), this can push against the goods from behind and push the goods along the support surface (30).

FIG. 14 and FIG. 15 show that the forks 31 have pads 39. The pads (39) may be adapted to the material to be gripped. Thus, a first embodiment, namely the one shown in FIG. 14, is conceivable in which the pads (39) are made of rubber and have a good coefficient of friction to securely grip a carton pack. Thus, a second embodiment, namely that shown in FIG. 15, is conceivable in which the pads (39) are slightly magnetic to securely grip a ferromagnetic package.

The support surface (30) and the carrier (37) and the timing/toothed belt (36) can be rotated about the vertical axis A so that a storage retrieval system (AS/RS) (7) can engage with shelves (5) of the rack row (2) closer to it as well as with shelves (5) of the rack row (2) located on the other side of the aisle (6).

The relative position of the storage retrieval system (AS/RS) (7) with respect to the rack row (2) can be determined and monitored as follows: A reference point of the storage retrieval system (AS/RS) (7) is defined in relation to the rack row (2). This reference point can, for example, be an end stop, i.e. a stop at the end of the rack row (2) beyond which the storage retrieval system (AS/RS) (7) cannot be moved. In a preferred embodiment, two reference points are provided, for example two end stops, namely one end stop at each end of the rack row (2), between which the storage retrieval system (AS/RS) (7) can move relative to the rack row (2). The position of the storage retrieval system (AS/RS) (7) relative to the reference point can now be determined from the tooth pitch of the stationary foot strap and monitoring of the number of revolutions of the gear wheel of the drive (14). Calibration runs and regular inspection runs are possible.

The manipulator (16) can grasp an item lying on a shelf 5 by entering the rack module (3) with forks (31) spread slightly wider than the width of the item, so that one fork (31) is positioned on each side of the item. By moving the forks (31) together by means of the drive (34), the forks (31) can be brought into contact with the material and exert a clamping force on the material. By retracting the forks (31) by moving the timing/toothed belt (36), the material can be moved from the forks (31) to the support surface (30).

The manipulator (16) can store an item lying on the support surface (30) onto a shelf (5) disposed adjacent the support surface (30) by moving the forks (31) and the slider (38) forward by moving the timing/toothed belt (36), and pushing the item from the support surface (30) onto the shelf (5) by means of the slider (38).

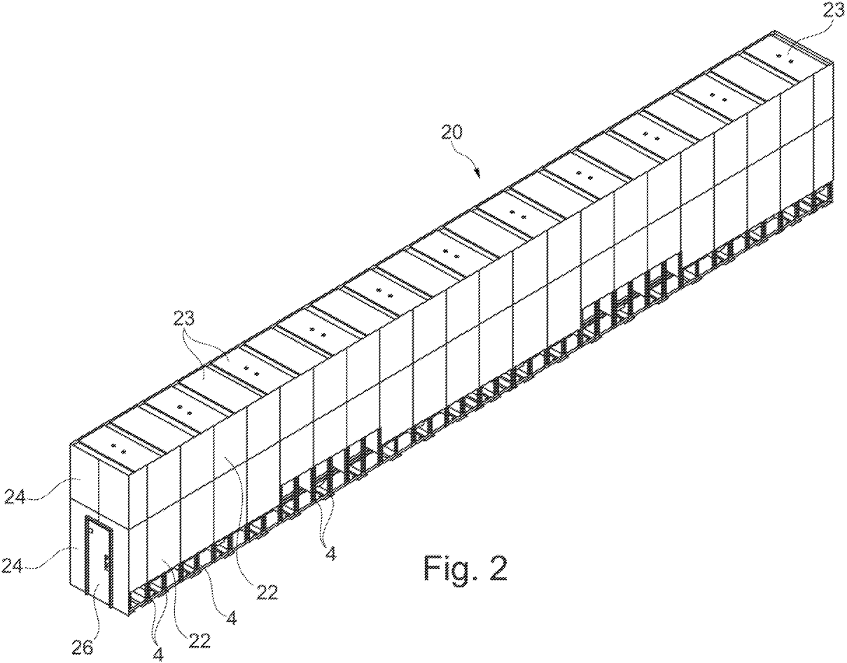

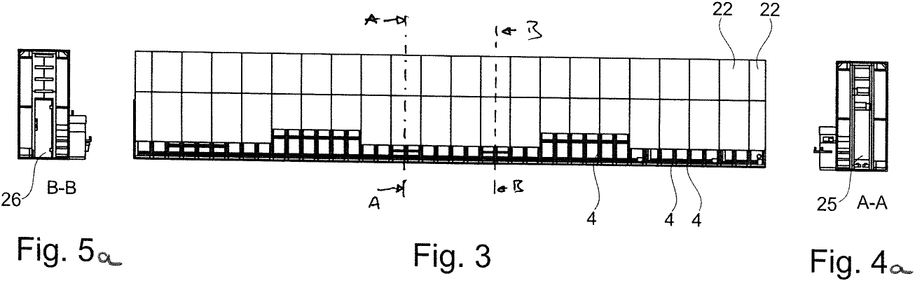

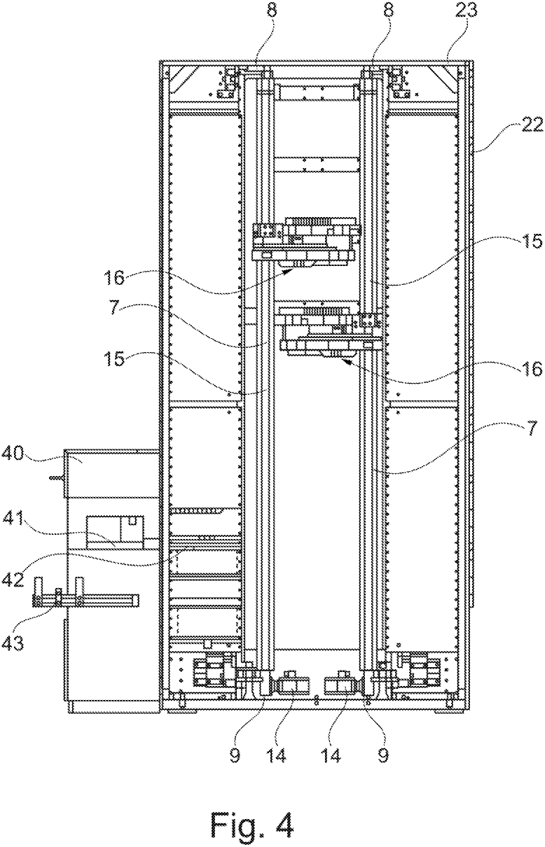

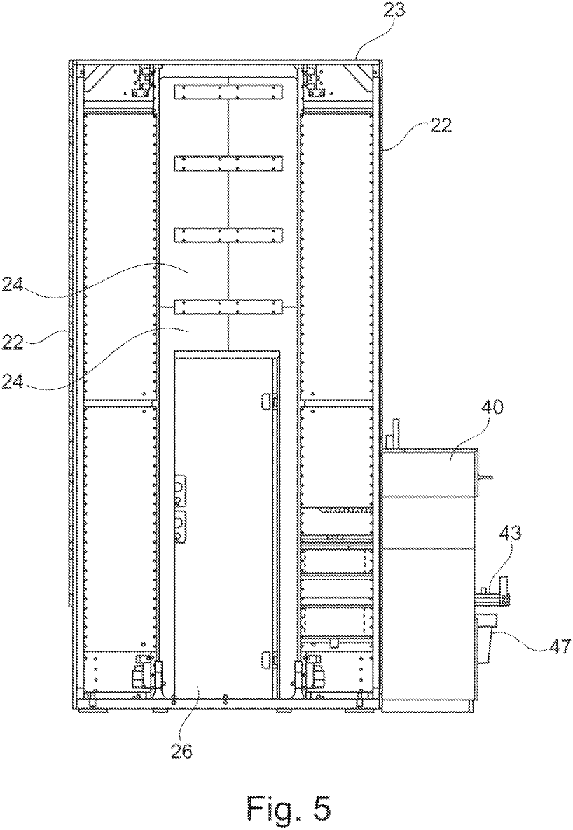

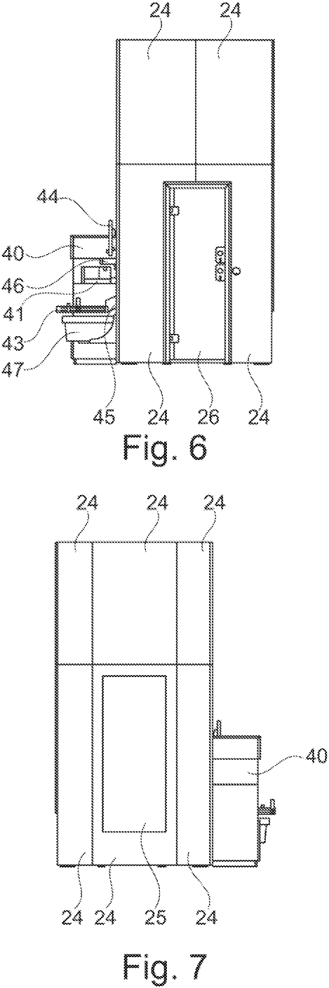

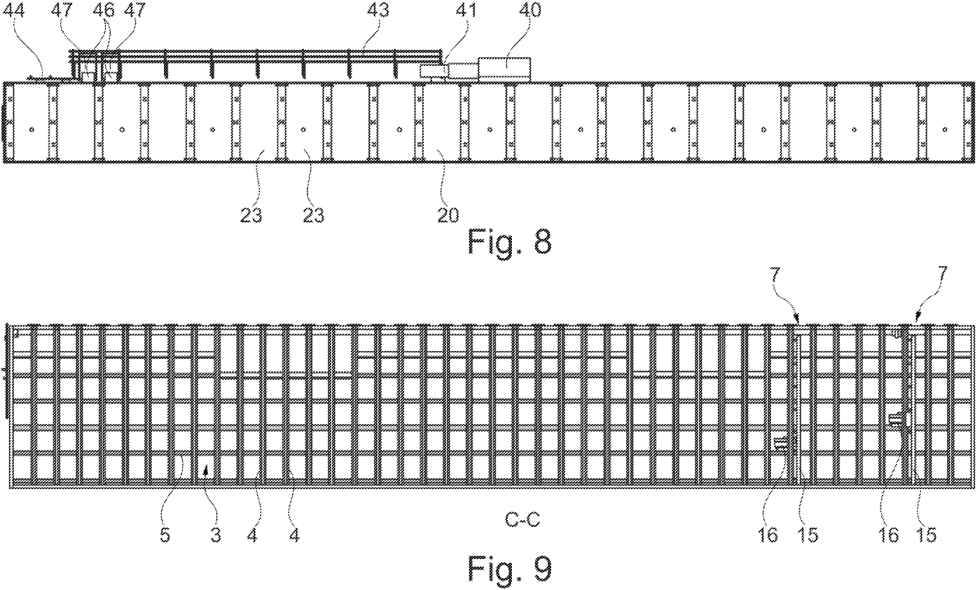

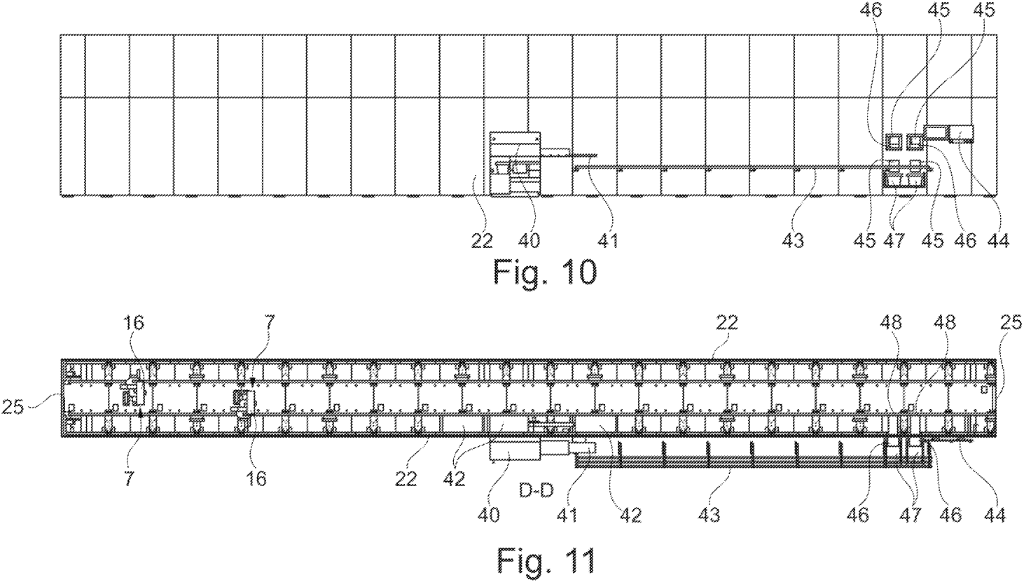

The picking device has wall panels (22). These form the respective rear walls of the rack rows (2) and close them off from the outside. In FIG. 2, some wall panels (22) have been omitted to provide a view of the struts (4) of the rack modules (3). Further, the picking device (1) has ceiling panels (23) that form the part of the ceiling (20) of the picking device (1). The ceiling panels (23) may be transparent or opaque to allow light into the picking device (1). The ceiling panels (23) may be opaque to keep light out of the picking device (1), for example to protect light-sensitive goods. The picking device has side panels (24). These form the respective side walls of the rack rows (2) and close them off from the outside. A window (25) may be provided in a side panel (24) to provide a view into the aisle (6). A door (26) may be provided on one side of the picking device (1).

A loading station (40) is provided on one side of the picking device (1). The loading station (40) has a conveyor belt (41) onto which goods to be stored can be placed. The goods lying on the conveyor (41) are conveyed to the loading station (40), identified there and transferred to trays (42) by a transfer device not shown in more detail. The trays (42) are within the access range of the storage retrieval system (AS/RS) (7), so that the storage retrieval system (AS/RS) (7) can pick up the goods located on the trays (42) by the gripper jaw (32). In particular, the procedure described in DE 10 2004 007 962 A1 can preferably be used for identification during conversion.

A shelf (43) for transport boxes is provided on one side of the picking device (1). The transport boxes can be arranged side by side on this tray (43), and the goods from the transport boxes can be placed on the conveyor belt (41).

A touch screen (44) is provided on one side of the picking device (1) as an interface for interaction between the operator and the picking device (1).

Four outputs (45) are provided on one side of the picking device (1), each of which is designed as a slide leading outwardly from the respective rack module (5). At the upper two outputs (45), an output surface (46) is provided on which an item sliding down the chute comes to rest and can be grasped by the operator. At the lower two outputs (45), transport boxes (47) are provided into which an item sliding down the slide falls. The upper ends (48) of the slides are within the access range of the storage retrieval system (AS/RS) (7), so that goods can be loaded onto the top of the slide.

The manipulator (16) has an interface at which the manipulator (16) can be connected to further components of the storage retrieval system (AS/RS) (7), and at which the manipulator (16) can be disconnected from the further components of the storage retrieval system (AS/RS) (7). The interface can be formed by the guide plate with rollers (19). The interface makes the manipulator (16) easily interchangeable. This allows for operating situations of the picking device (1) in which a manipulator (16) of a first type, which is particularly well suited for retrieving and/or storing a first type of goods (for example, flat packs) but somewhat less well suited for retrieving and/or storing a second type of goods (for example, bottles), is exchanged for a manipulator (16) of a second type, which is better suited for retrieving and/or storing a second type of goods (for example, bottles). Depending on the design of the interface, this exchange can be automated so that it is not necessary for the operator to carry-out the exchange.

The picking device (1) has two storage retrieval systems (AS/RS) (7). One of those storage retrieval systems (AS/RS) (7) is equipped with a manipulator (16) of the first type and is particularly capable of storing and/or retrieving flat packages, for example. The other storage retrieval system (AS/RS) (7) is equipped with a manipulator (16) of the second type and is particularly capable of storing and/or retrieving bottles, for example.

The side wall of the picking device (1) comprising the window (25) can be opened as a whole and a storage and retrieval system (AS/RS) (7) can be removed as such from the resulting opening. This makes it possible, for example, to completely remove or completely replace a storage and retrieval system (AS/RS) (7) for maintenance purposes.

1-4. (canceled)

5. A method for repairing a picking device, wherein the picking device comprises a rack to store goods, a storage retrieval system configured for storing goods in specific locations of the rack and/or configured for retrieving goods located in a specific location of the warehouse, and a controller designed to control movements of the storage retrieval system and/or movements of components of the storage retrieval system, and wherein the picking device includes a maintenance unit, the controller operative to move the storage retrieval system to the maintenance location and/or the controller operative to move the storage retrieval system away from the maintenance unit, the method comprising:
moving a first storage retrieval system to the maintenance unit;
removing the first storage retrieval system from the picking device at the maintenance unit;
inserting a second storage retrieval system into the picking device at the maintenance unit; and
moving the second storage retrieval system away from the maintenance unit.

6. The method according to claim 5, further comprising providing a rail leading from a working area located in front of the rack to the maintenance location, and
moving the storage retrieval system along the rail from the working unit to the maintenance location.

7. The method according to claim 5, further comprising providing a rail leading from a working area located in front of the rack to the maintenance location, and moving the storage retrieval system along the slide from the maintenance location to the working area.

8. The method according to claim 5, wherein the picking device comprises an interior space, and wherein the maintenance unit is outside of the interior space.

9. The method according to claim 5, further comprising performing a calibration run by the storage retrieval system which is moved away from the maintenance unit into a working area of the storage retrieval system.
